(19) United States
(12) Patent Application Publication
(10) Pub. No.: US 2011/0051929 A1
(43) Pub. Date: Mar. 3, 2011

(54) IMAGE PROCESSING APPARATUS, ELECTRONIC CERTIFICATE CREATION METHOD THEREOF AND RECORDING MEDIUM

(75) Inventor: Akemi MORITA, Nishinomiya-shi (JP)

(73) Assignee: KONICA MINOLTA BUSINESS TECHNOLOGIES, INC., Chiyoda-ku (JP)

(21) Appl. No.: 12/872,714

(22) Filed: Aug. 31, 2010

(30) Foreign Application Priority Data
Sep. 2, 2009 (JP) 2009-203156

(51) Int. Cl. H04L 9/00

(52) U.S. Cl. 380/44

(57) ABSTRACT

An image processing apparatus includes: a key creator that creates one set of a secret key and a public key for each user; a reader that reads out an electronic certificate to certify a user, created by a certificate authority, and the user's own secret key, from a portable recording medium having this electronic certificate and the user's own secret key recorded therein; and a certificate creator that creates an electronic certificate including the public key created by the key creator, by giving a signature using the user's own secret key read out by the reader.

This application claims priority under 35 U.S.C. §119 to Japanese Patent Application No. 2009-203156 filed on Sep. 2, 2009, the entire disclosure of which is incorporated herein by reference in its entirety.

### BACKGROUND OF THE INVENTION

1. Field of the Invention

The present invention relates to an image processing apparatus such as an image forming apparatus capable of creating one set of a secret key and a public key for each user; an electronic certificate creation method for creating an electronic certificate to certify that it is the image processing apparatus carrying the created public key; and a computer readable recording medium having an electronic certificate creation program recorded therein to make a computer of the image processing apparatus implement the electronic certificate creation method.

2. Description of the Related Art

The following description sets forth the inventor's knowledge of related art and problems therein and should not be construed as an admission of knowledge in the prior art.

In recent years, to prevent falsification of data or theft of mail sender's identity, an electronic mail (hereinafter will be also referred to as “mail”, simply) including various data with an electronic signature or an electronic certificate attached to the data, is commonly transmitted to a recipient.

Meanwhile, there is a technology that is an image processing apparatus that creates a secret key and a public key for each user or user account and further creates an electronic certificate signed by an authentication server to certify that it is the image processing apparatus carrying this public key (as suggested in Japanese Unexamined Laid-open Patent Publication No. 2007-150832).

Using this technology, a secret key and a public key are created for each user account as described above, meanwhile an electronic signature is given to an electronic certificate using a secret key carried by the authentication server. Thus, the electronic certificate simply certifies that it is the image processing apparatus carrying the public key, and even if a sender user transmits to a recipient user, an electronic mail with this electronic certificate attached thereto, the recipient user won't be able to make sure if the electronic mail really came from the sender user. This has been a problem.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the preset invention to provide an image processing apparatus that is capable of creating a set of a public key and a secret key for a user and further creating an electronic certificate including this public key, which certifies a connection to this user, so that a recipient user could make sure that a received electronic mail really comes from the user if the electronic mail includes the electronic certificate.

It is another object of the present invention to provide an electronic certificate creation method implemented by the image processing apparatus.

It is yet another object of the present invention to provide a computer readable recording medium having an electronic certificate creation program recorded therein to make a computer of the image processing apparatus implement the electronic certificate creation method.

According to a first aspect of the present invention, an image processing apparatus includes:
a key creator that creates one set of a secret key and a public key for each user;
a reader that reads out an electronic certificate to certify a user, created by a certificate authority, and the user's own secret key, from a portable recording medium having this electronic certificate and the user's own secret key recorded therein; and
a certificate creator that creates an electronic certificate including the public key created by the key creator, by giving a signature using the user's own secret key read out by the reader.

According to a second aspect of the present invention, an electronic certificate creation method includes:
creating one set of a secret key and a public key for each user;
reading out an electronic certificate to certify a user, created by a certificate authority, and the user's own secret key, from a portable recording medium having this electronic certificate and the user's own secret key recorded therein; and
creating an electronic certificate including the public key created for the user, by giving a signature using the user's own secret key read out therefrom.

According to a third aspect of the present invention, a computer readable recording medium has an electronic certificate creation program recorded therein to make a computer of an image processing apparatus execute:
creating one set of a secret key and a public key for each user;
reading out an electronic certificate to certify a user, created by a certificate authority, and the user's own secret key, from a portable recording medium having this electronic certificate and the user's own secret key recorded therein; and
creating an electronic certificate including the public key created for the user, by giving a signature using the user's own secret key read out therefrom.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view showing a configuration of an image processing system in which an image processing apparatus according to one embodiment of the present invention is employed;

FIG. 2 is a block diagram showing a configuration of the image processing apparatus employed in the image processing system of FIG. 1;

FIG. 3 is a flowchart representing a procedure to issue (create) an electronic certificate, executed by the image processing apparatus;

FIG. 4 is a view to explain a connection between a user's own electronic certificate and an electronic certificate created by the image processing apparatus;

FIG. 5 is a flowchart representing a procedure to create an electronic certificate when a login user turns ON the mode for transmitting to a predetermined destination address, an electronic mail including image data read out from a document by a scanner;

FIG. 6 is a flowchart representing a procedure to create an electronic certificate when a user logs in the image processing apparatus;

FIG. 7 is a flowchart representing a procedure executed when a user intends to log in the image processing apparatus by entering an ID and a password;

FIG. 8 is a view to explain another embodiment of the present invention and the method for using an electronic certificate created by the image processing apparatus;

FIG. 9 is a flowchart representing a procedure to implement the embodiment of the present invention of FIG. 8, executed by the image processing apparatus;

FIG. 10 is a flowchart representing a procedure, in which the expiration date of an electronic certificate created by the image processing apparatus is checked out on a regular basis, and if the expiration date has passed, the electronic certificate and a secret key also created by the image processing apparatus are erased;

FIG. 11 is a flowchart representing a procedure to erase an electronic certificate and secret key created for a user, when the image processing apparatus creates a new electronic certificate and secret key for the same user;

FIG. 12 is a flowchart representing a procedure to erase an existing electronic certificate and secret key another time; and

FIG. 13 is a flowchart representing a procedure to erase an existing electronic certificate and secret key yet another time.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

Hereinafter, one embodiment of the present invention will be explained with reference to Figures.

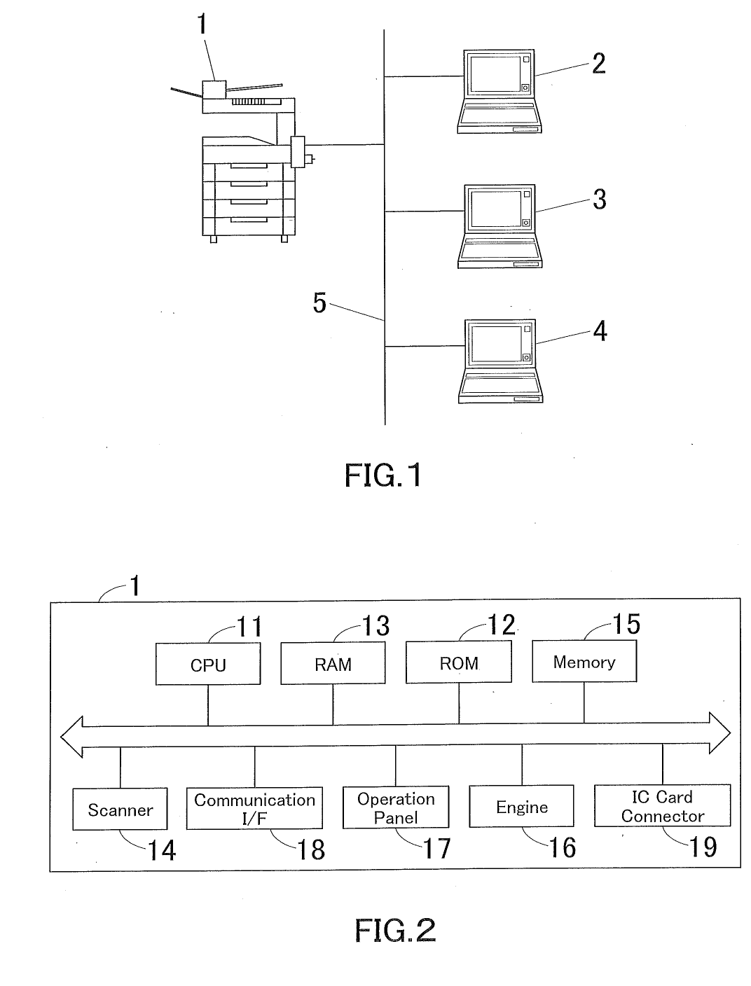

FIG. 1 is a view showing a configuration of an image processing system in which an image processing apparatus according to one embodiment of the present invention is employed. This image processing system includes an image processing apparatus 1, a user terminal 2 that is a personal computer, an authentication server 3 that performs user authentication, and a mail server 4. The image processing apparatus 1, the user terminal 2, the authentication server and the mail server 4 are interconnected via a network 5.

In this embodiment, a MFP (Multi Function Peripheral) that is a multifunctional digital image forming apparatus collectively having a plurality of functions such as the copy function, the printer function, the scan function, the facsimile function and other functions, is employed as the image processing apparatus 1. Hereinafter, the image processing apparatus 1 also will be referred to as “MFP” in the following description and Figures.

FIG. 2 is a block diagram schematically showing a configuration of the image processing apparatus 1.

As shown in FIG. 2, the image processing apparatus 1 includes a CPU 11, a ROM 12, a RAM 13, a scanner 14, a memory 15, an engine 16, an operation panel 17, a communication interface (referred to as “communication I/F” in this FIG. 18, an IC card connector 19 and etc.

The CPU 11 centrally controls the entire image processing apparatus 1 so as to enable the basic functions such as the copy function, the print function, the scanning function and the facsimile function. Furthermore, the CPU 11 creates one set of a secret key and a public key for a user and also erases an existing secret key and etc., at login or at another predetermined time; reads out a user's own electronic certificate and secret key from an IC card connected to the IC card connector 19; creates an electronic certificate including the created public key; and performs other operations. Detailed explanation will be provided later.

The ROM 12 is a memory that records in itself an operation program for the CPU 11, and other data.

The RAM 13 is a memory that provides a work area for the CPU 11 to execute processing according to an operation program.

The scanner 14 is a reader that reads an image of a document placed on a document table (not shown in this Figure) to output image data obtained therefrom.

The memory 15 is a nonvolatile recording device, for example a hard disk drive (HDD), and records in itself image data read out from a document by the scanner 14; data received from another image forming apparatus, a user terminal or etc.; various application programs; and other data. Furthermore, the memory 15 records in itself, a secret key and a public key created for each user as described above; a created electronic certificate; an ID and a password issued for each user; and other data, with a connection to each other.

Furthermore, in this embodiment, the memory 15 records in itself, information of the types and versions of the mailing software applications (hereinafter will be referred to as “mailers”) installed on the user terminal 2 and the suitable hush functions used by the mailers for generation of an electronic signature, with connections to each other, as shown in a matching table 15a of FIG. 8. For example, the memory 15 records the hush function “SHA 1” with a connection to the mailer “Outlook”, further records the hush functions “SHA 1” and “SHA 256” with a connection to the mailer “Becky”. The image processing apparatus 1 carries various hush functions, and calculate a hush value for data using one of the hush functions, suitable for a mailer.

The engine 16 prints image data read out from a document by the scanner 14, print data received from the user terminal 2 and other data, according to a specified mode.

The operation panel 17 is used for various entry operations and other operations, and includes a display 17a, for example a touch-panel liquid crystal display that displays on itself messages, operation screens and etc., and a key entry portion 17b having numeric keys, a start key, a stop key and other keys.

The communication interface 18 controls data communication with the user terminal 2, the authentication server 3, the mail server 4 and etc. on the network 5.

The IC card connector 19 connects to an IC card that is an example of a portable recording medium. In this IC card, an electronic certificate to certify the user owning this IC card, which is issued by a certificate authority that is an electronic certificate issuing institution, a secret key of the user certified by the electronic certificate and login information to log in the image processing apparatus 1 are recorded. Hereinafter, the IC card will be also referred to as “PKI (Public Key Infrastructure) card”.

The authentication server 3 judges whether or not to authorize a user who is trying to log in the image processing apparatus 1, to use the image processing apparatus 1, based on user information recorded in advance in the server itself. Alternatively, this judgment process may be performed inside of the image processing apparatus 1.

The mail server 4 serves to exchange electronic mails.

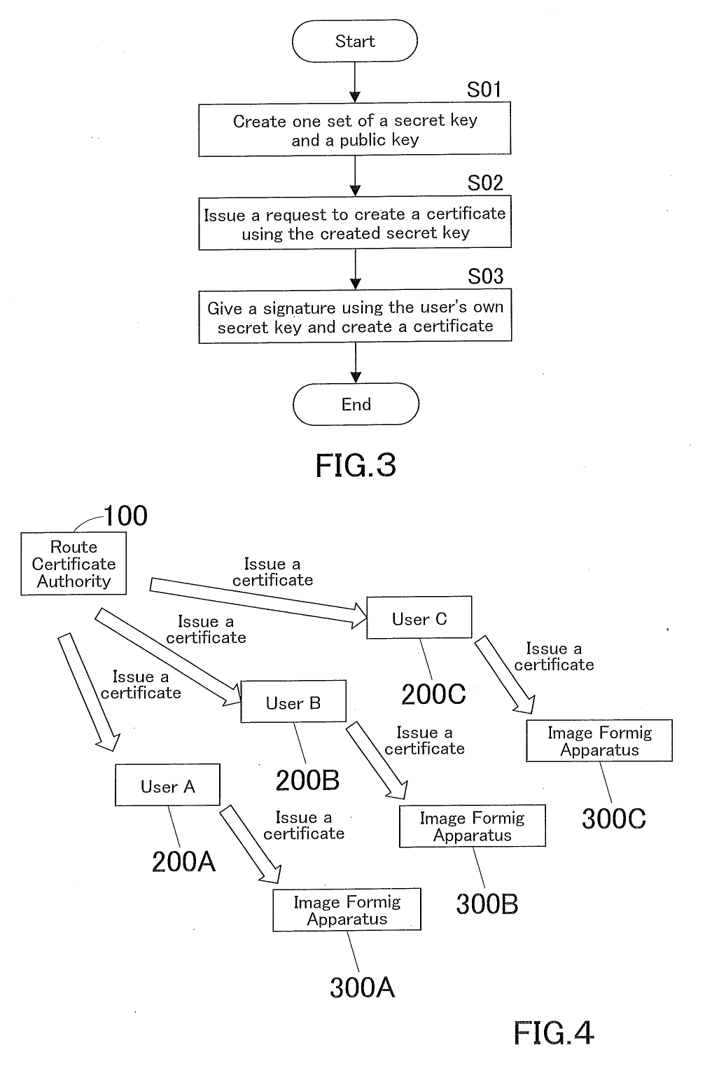

Hereinafter, the image processing apparatus 1's procedure to issue (create) an electronic certificate will be explained with reference to the flowchart shown in FIG. 3. The flowchart shown in FIG. 3 and the following flowcharts are executed by the CPU 11 of the image processing apparatus 1, according to an operation program recorded in the ROM 12, the memory 15 or another recording medium.

In Step S01, one set of a secret key and a public key are created in the image processing apparatus 1 for a user who has just been logged in the image processing apparatus by connecting a PKI card to the IC card connector 19. Different sets of a secret key and a public key are created for respective users.

Subsequently, in Step S02, a request to create a certificate (CSR: Certificate Signing Request) using the created secret key is issued. In response to the request, a signature button is displayed on a display of the operation panel 17.

And a user presses the signature button. Then the user's own electronic certificate and secret key are read out from the PKI card. In Step S03, a signature is given to the created public key using the readout secret key, and an electronic certificate including this public key is created. In addition to the public key, the electronic certificate also includes information of the image processing apparatus 1 and an expiration date of the electronic certificate. A certain period of time may be set in advance to determine the expiration date. The user's own electronic certificate that is issued by the certificate authority and read out from the PKI card, is recorded in the memory 15.

As described above, a signature is given to an electronic certificate including a public key created by the image processing apparatus 1 for a user using this user's own secret key certified by a certificate authority. Thus, an electronic certificate created by the image processing apparatus 1 does not certify the image processing apparatus 1 itself, but it certifies the user by its certificate chain.

For example, as shown in FIG. 4, Users A, B and C have their own electronic certificates 200A, 200B and 200C issued by a route certificate authority 100. This means that electronic certificates 300A, 300B and 300C created by the image forming apparatus 1 for the Users A, B and C, including electronic signatures given using their own secret keys, certify the Users A, B and C, respectively, just like their own electronic certificates 200A, 200B and 200C. And thus, for example, the image processing apparatus 1 generates an electronic signature for image data read out by the scanner 14, using the electronic certificate 200A, 200B and 200C, gives it to the image data and transmits to a destination address, an electronic mail including the image data. Then, the user at the destination address will be able to make sure that the electronic mail really comes from User A, B and C, simply by checking out the signature, without using their PKI cards.

Furthermore, the cost can be saved, since no server apparatus to issue electronic certificates is necessary anymore. Also, there is no burden placed on the network due to creation of an electronic certificate.

Furthermore, the cost for time and money can be saved since users use their own electronic certificates and do not have to be certified by a right certificate authority.

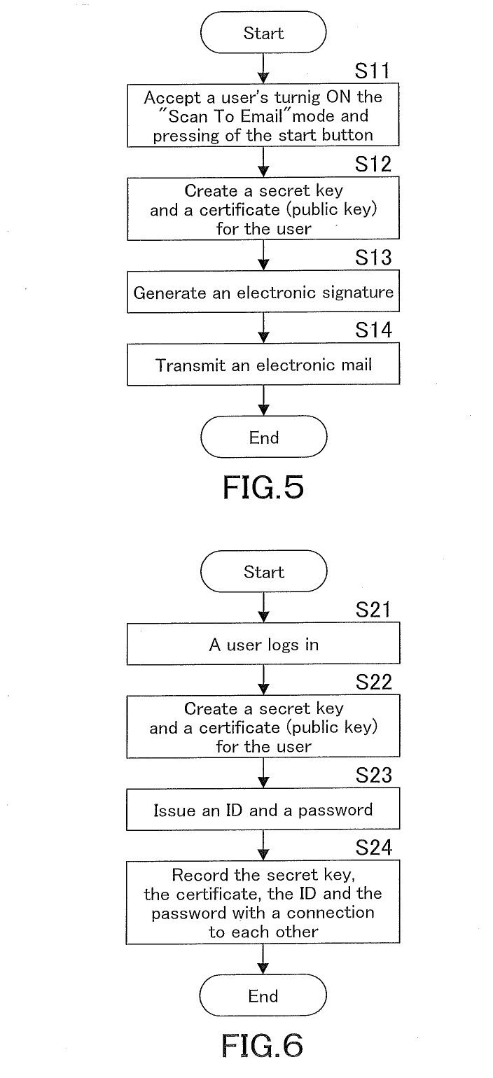

The electronic certificates 300A, 300B and 300C may be created anytime. For example, the electronic certificates 300A, 300B and 300C may be created when a login user turns ON the “Scan To Email” mode that is the mode for transmitting to a predetermined destination address, an electronic mail including image data read out from a document by the scanner 14. FIG. 5 shows a flowchart that is one example of this procedure.

A login user turns ON the “Scan To Email” mode and presses the start button of the operation panel 17, then this operation is accepted in Step S11.

Subsequently, in Step S12, a secret key and an electronic certificate (public key) are created for the user. The procedure to create a secret key and an electronic certificate (public key) is executed according to the flowchart shown in FIG. 3.

And in Step S13, an electronic signature (digital signature) is generated for image data read out from a document by the scanner 14, according to user operation. The electronic signature is generated using a hush function and the secret key created by the image processing apparatus 1. If the user connects a PKI card to the card connector 19, an electronic signature may be generated using the user's own secret key read out from the PIK card. In this case, if the user disconnects the PKI card after creating the electronic certificate in Step S12, the user's own secret key cannot be read out from the PKI card. However, the procedure never stops since an electronic signature can be generated using the secret key created by the image processing apparatus 1.

And the user presses the start button. Then in Step S14, an electronic mail including the image data, the generated electronic signature, the user's own electronic certificate 200A, 200B or 200C recorded in the memory 15 and the electronic certificate 300A, 300B or 300C created by the image processing apparatus 1, are transmitted to a specified destination address.

And the user at the destination address can make sure that the electronic mail really comes from the sender user, from the electronic certificate 200A, 200B or 200C issued by the certificate authority and the electronic certificate 300A, 300B or 300C created by the image processing apparatus 1, as described above. The user also can make sure that the image data is all right without falsification, since the electronic signature is decrypted with the public key created by the image processing apparatus 1.

The electronic certificates 300A, 300B and 300C may be created when a user logs in the image processing apparatus 1. FIG. 6 shows a flowchart that is one example of this procedure.

A user logs in the image processing apparatus 1 using the PKI card, then a secret key and an electronic certificate (public key) are created for the user, in Step S21. The procedure to create a secret key and an electronic certificate (public key) is executed according to the flowchart shown in FIG. 3.

And in Step S23, an ID and a password are issued. The issued ID and password are displayed on a display of the operation panel 17 or transmitted to the user's electronic mail address, so that the user could know. Alternatively, an ID and a password may be entered according to user operation. The ID and the password are issued by the user's pressing of an ID and password issuance button not shown in this Figure.

Then in Step S24, the created secret key, the electronic certificate (public key) 300A, 300B or 300C, the issued ID and password and the electronic certificate 200A, 200B or 200C read out from the user's PKI card, are recorded in the memory 15, with a connection to each other.

An ID and a password are issued in this way described above. Thus, even when a user hopes to log in the image processing apparatus 1 without a PKI card because it could be broken in a delicate state or because it is occupied for another use, the user can log in the image processing apparatus 1 without a PKI card and give an electronic signature, by entering an ID and a password.

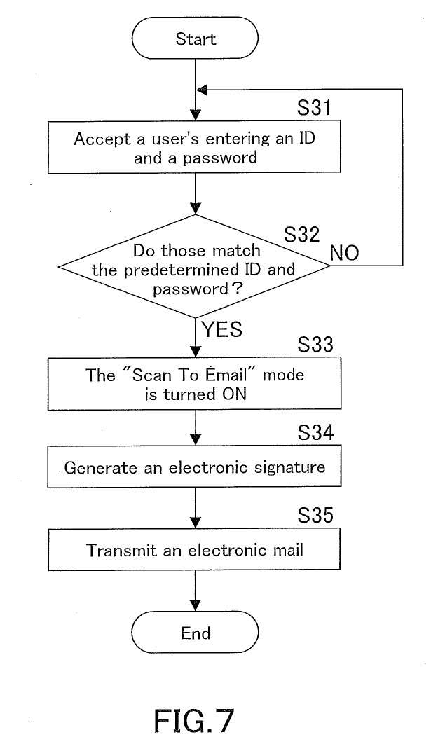

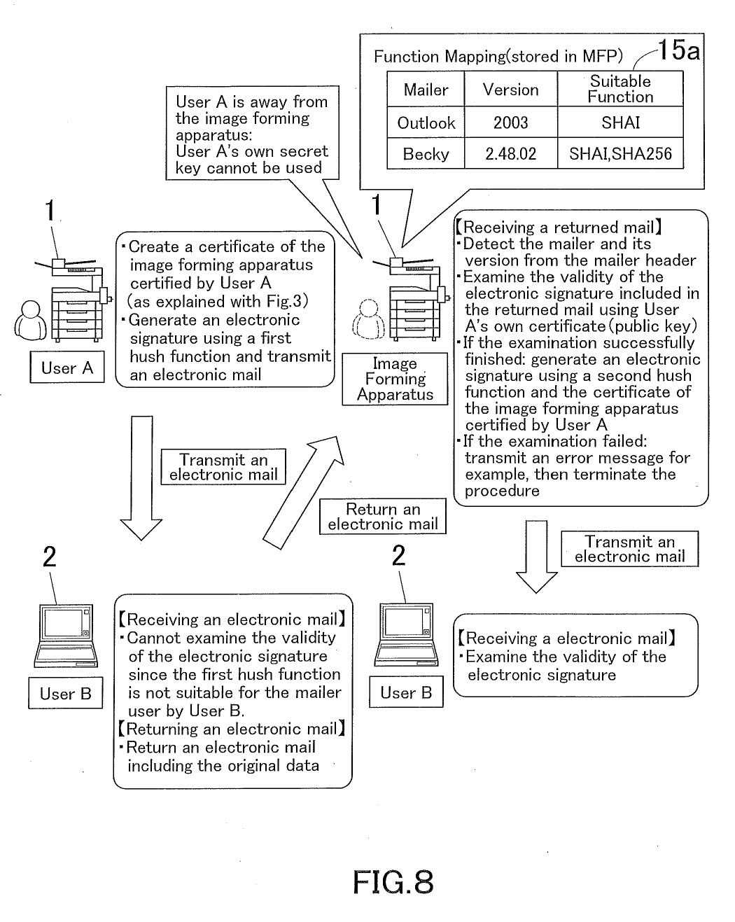

FIG. 7 shows a flowchart representing a procedure executed when a user intends to log in the image processing apparatus 1 by entering an ID and a password.

In Step S31, a user enters an ID and a password via the operation panel 17 and this operation is accepted. Then, it is judged in Step S32, whether or not those match the predetermined ID and password. If those do not match (NO in Step S32), the routine goes back to Step S31 and waits until entry of another ID and password.

If those match the predetermined ones (YES in Step S32), the user's login is permitted, and the user turns ON the “Scan To Email” mode in Step S33. After that, an electronic signature is generated using a secret key suitable for the ID and the password in Step S34, and this is transmitted in Step S35. The Step S34 to create an electronic signature and the Step S35 to transmit the electronic signature correspond to the Step S13 and the Step S14 of the flowchart shown in FIG. 5, respectively.

FIG. 8 is a view to explain another embodiment of the present invention and the method for using an electronic certificate created by the image processing apparatus 1. In this embodiment, an electronic certificate is given to image data read out by the scanner 14 of the image processing apparatus 1 and an electronic mail including this image data is transmitted to a destination address.

Initially, User A, for example, logs in the image processing apparatus 1. Then, the image processing apparatus 1 creates a set of a secret key and a public key for the user, and also creates the electronic certificate 300A including this public key, using a secret key recorded in the user's own PKI card. The procedure to create them has been previously explained with reference to the flowchart shown in FIG. 3.

Subsequently, a hush value for the image data read out from a document by the scanner 14, is calculated. The hush value is calculated using a first hush function (see Circled No. 1 in FIG. 8). Then, the hush value is converted using User A's own secret key recorded in the PKI card, and thereby an electronic signature is obtained. Alternatively, the hush value may be converted using the secret key created by the image processing apparatus 1.

And then, an electronic mail including the image data that is the original data, the generated electronic signature, the electronic certificate 300A created by the image processing apparatus 1 and User A's own electronic certificate 200A, is transmitted to a destination address.

Receiving this electronic mail, User B examines the validity of the electronic signature included in the received mail, by operating a mailer installed on his/her own user terminal 2. If the hush function used by the image processing apparatus 1 is suitable for the mailer of the user terminal 2, User B can easily examine the validity of the electronic signature, in other words, make sure if the image data is all right without falsification.

However, if the hush function used by the image processing apparatus 1 is not suitable for the mailer of the user terminal 2, User B cannot examine the validity of the electronic signature. In this case, the user terminal 2 returns to the image processing apparatus 1, an electronic mail including the original data received therefrom.

Receiving this electronic mail, the image processing apparatus 1 detects the type of the mailer of the user terminal 2 and its version from the mail header of the returned mail.

Since the matching table 15a storing the types and versions of mailers and the hush functions suitable for mailers, is recorded in the memory 15 of the image processing apparatus 1, a hush function (a second hush function) suitable for the type and version of the mailer of the user terminal 2, is detected from the matching table 15a.

And then, using User A's own public key, User B examines the validity of the electronic signature included in the returned mail and makes sure if the image data is all right without falsification. If the examination failed, an electronic mail is transmitted to the sender address to let him/her know. If the examination successfully finished, a hush value is calculated using the second hush function, and the hush value is converted using the secret key created by the image processing apparatus 1, and thereby an electronic signature is obtained. As described above, an electronic signature is generated for the second time, using the secret key created by the image processing apparatus 1. This means that an electronic signature can be generated even if User A has been logged out of the image processing apparatus 1.

After creation of the electronic signature, an electronic mail including the image data that is the original data, the electronic signature, the electronic certificate and etc., is transmitted to the destination address, in the same way as the first electronic mail transmission.

Receiving this electronic mail again, User B examines the validity of the electronic signature, by operating the user terminal 2. Since the hush function used for generation of the electronic signature is suitable for the mailer of the user terminal 2, User B can make sure if the image data is all right without falsification.

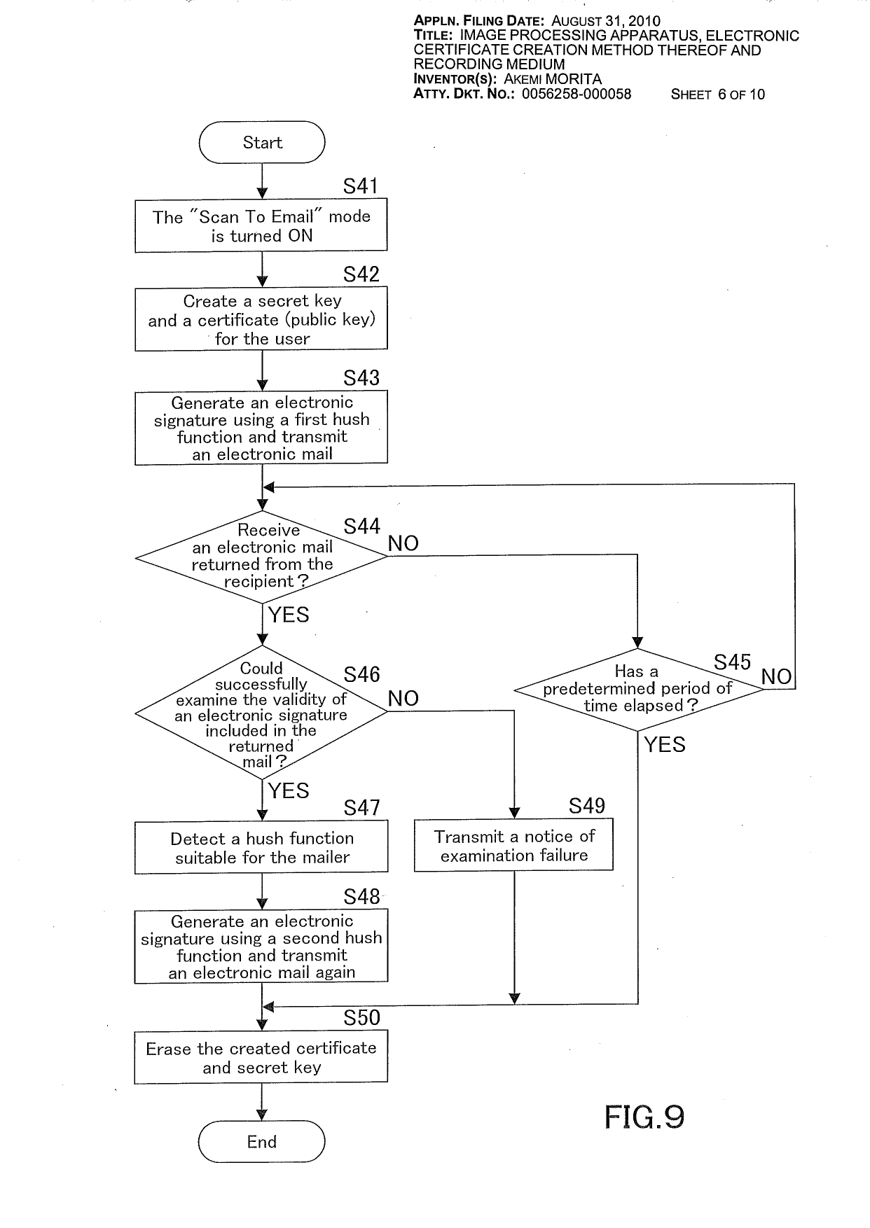

FIG. 9 is a flowchart representing the procedure to implement the embodiment explained with FIG. 8, executed by the image processing apparatus 1.

A login user turns ON the “Scan To Email” mode and presses the start button of the operation panel 17, then this operation is accepted in Step S41.

Subsequently, in Step S42, a secret key and an electronic certificate (public key) are created for the user. The procedure to create a secret key and an electronic certificate (public key) is executed according to the flowchart shown in FIG. 3.

In Step S43, a hush value for image data read out from a document by the scanner 14 is calculated using a first hush function, according to user operation; the hush value is converted using the user's own secret key, and thereby an electronic signature is obtained; and an electronic mail including the original image data, the electronic signature, the electronic certificate and etc., is transmitted to a destination address.

And in Step S44, it is judged whether or not an electronic mail including the original data is returned from the recipient (destination address). If such an electronic mail is not returned (NO in Step S44), then it is judged in Step S45, whether or not a predetermined period of time has elapsed. If a predetermined period of time has not elapsed (NO in Step S45), the routine goes back to Step S44. If such an electronic mail is not returned within a predetermined period of time (YES in Step S45), the routine proceeds to Step S50, since it means that the first hush function is suitable for the mailer of the user terminal 2 at the destination address.

In Step S44, if such an electronic mail is returned from the recipient (destination address) (YES in Step S44), the validity of an electronic signature included in the electronic mail is examined, and it is judged in Step S46, whether or not the examination successfully finished. If the examination failed (NO in Step S46), a notice of examination failure is transmitted to the destination address in Step S49. After that, the routine proceeds to Step S50.

If the examination successfully finished (YES in Step S46), a second hush function suitable for the mailer of the user terminal 2 is detected in Step S47. And in Step S48, a hush value for the image data is calculated using the second hush function; the hush value is converted using the secret key created by the image processing apparatus 1, and thereby an electronic signature is obtained; and an electronic mail including the original image data, the electronic signature, the electronic certificate and etc., is transmitted again to the destination address. After that, the routine proceeds to Step S50.

In Step S50, the created electronic certificate and secret key are erased and the routine terminates.

As described above, if a hush function used by the image processing apparatus 1 for generation of an electronic signature is not suitable for a mailer of the user terminal 2 at the destination address, an electronic signature can be generated for the second time, using another hush function suitable for the mailer, and thus the user terminal 2 can properly examine the validity of an electronic signature included in a received electronic mail. Furthermore, an electronic signature is generated for the second time using a secret key created by the image processing apparatus 1, not using a user's own secret key, and thus when an electronic mail is received for the second time, an electronic signature is automatically generated without a user's own secret key or existence of the user.

Meanwhile, the existing electronic certificate and secret key are erased in Step S50 of FIG. 9, so that security could be ensured and a lack of memory capacity due to the existence of unnecessary secret keys and electronic certificates, could be prevented. However, these are not necessarily erased at a limited time.

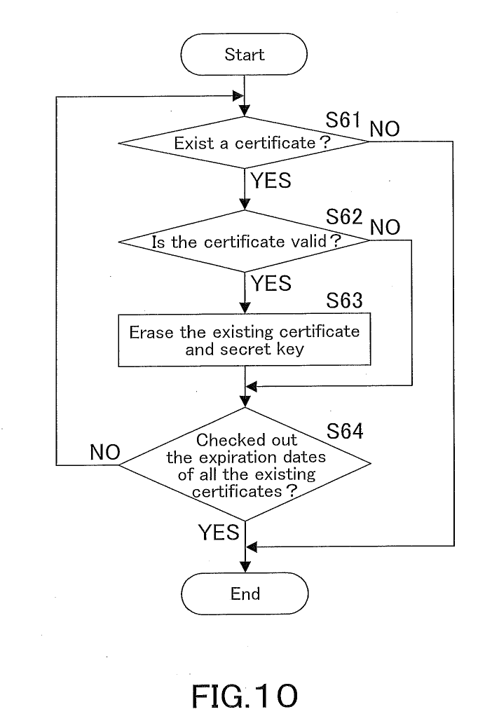

FIG. 10 is a flowchart representing a procedure, in which the expiration date of an electronic certificate created by the image processing apparatus 1 is checked out on a regular basis, and if the expiration date has passed, the electronic certificate and a secret key also created by the image processing apparatus 1 are erased.

In Step S61, it is judged whether or not there exist any electronic certificates created by the image processing apparatus 1. If there does not exist (NO in Step S61), the routine immediately terminates. If there exits such an electronic certificate (YES in Step S61), then it is judged in Step S62, whether or not the electronic certificate is valid, by checking out its expiration date. If it is valid (YES in Step S62), the routine proceeds to Step S64. If it is not valid any more (NO in Step S62), the existing electronic certificate and secret key are erased in Step S63. After that, the routine proceeds to Step S64.

In Step S64, it is judged whether or not the expiration dates of all the existing electronic certificates have been checked out. If those have been checked out (YES in Step S64), the routine terminates. If those have not been checked out (NO in Step S64), the routine goes back to Step S61, and the routine repeats Steps S61 through S64 until the expiration dates of all the existing electronic certificates have been checked out. And the procedure shown in FIG. 10 is repeatedly executed on a regular basis.

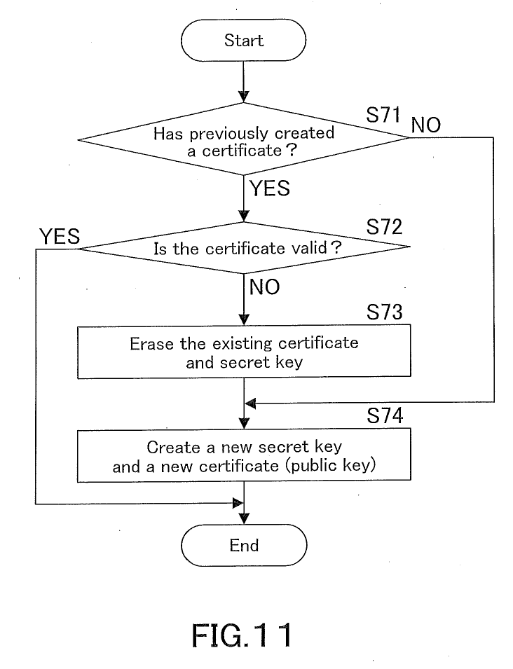

FIG. 11 is a flowchart representing a procedure executed by the image processing apparatus 1, in which an invalid electronic certificate and a secret key created for a user are erased, for example when this user logs in again or trying to transmit an electronic mail including image data and a new electronic certificate is created for the user.

In Step S71, it is judged whether or not an electronic certificate has been previously created for a login user. If it has not been created (NO in Step S71), the routine proceeds to Step S74, wherein the procedure to create an electronic certificate is executed according to the flowchart shown in FIG. 3.

If it has been previously created (YES in Step S71), then it is judged in Step S72, whether or not the electronic certificate is valid, by checking out its expiration date. If it is valid (YES in Step S72), the routine terminates without creation of an electronic certificate. In this case, creation of an unnecessary electronic certificate is prevented and the existing electronic certificate will be reused.

Meanwhile, the electronic certificate is not valid (NO in Step S72), the existing electronic certificate and secret key are erased in Step S73, and a new electronic certificate is created in Step S74.

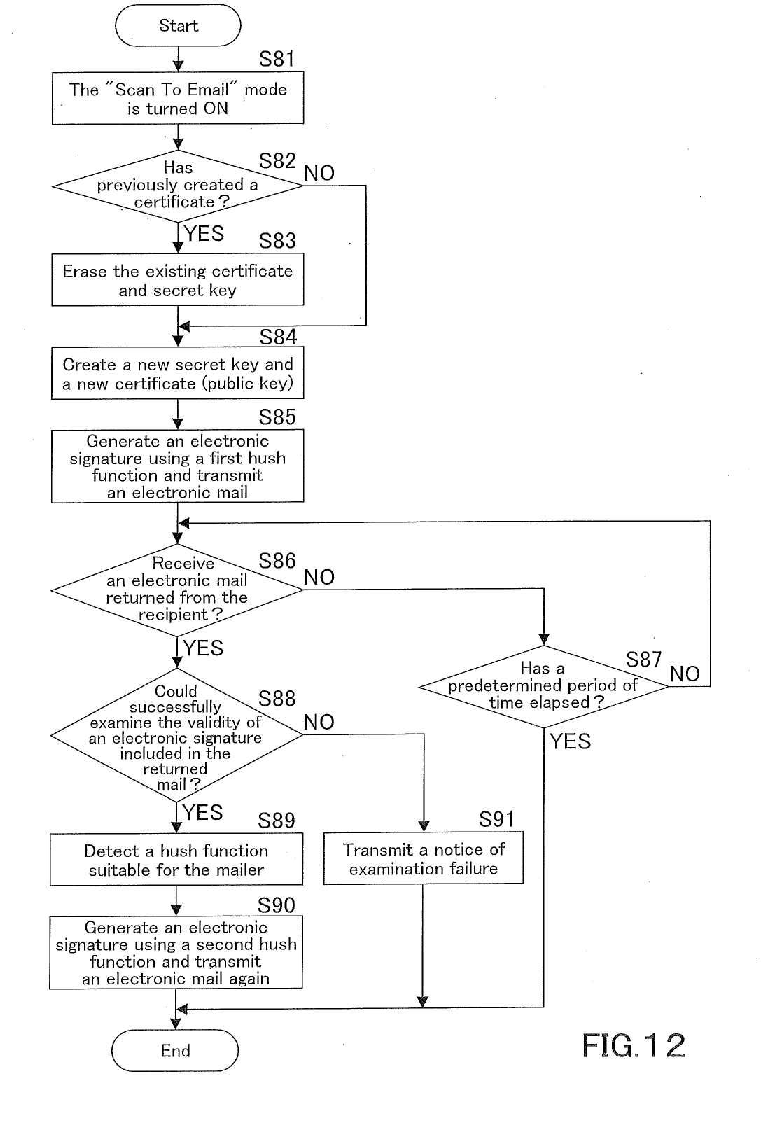

FIG. 12 is a flowchart representing a procedure to erase an existing electronic certificate and secret key another time, in which an electronic certificate and a secret key created for a user are erased when a new electronic certificate is created for the same user.

A login user turns ON the “Scan To Email” mode and presses the start button of the operation panel 17, then this operation is accepted in Step S81.

Subsequently, it is judged in Step S82, whether or not an electronic certificate has been previously created for the user. If it has been created (YES in Step S82), the existing electronic certificate and secret key are erased in Step S83, then the routine proceeds to Step S84. If it has not been created (NO in Step S82), the routine proceeds directly to Step S84.

In Step S84, a new secret key and a new electronic certificate (public key) are created for the user. The procedure to create a new secret key and a new electronic certificate (public key) is executed according to the flowchart shown in FIG. 3.

And in Step S85, a hush value for image data read out from a document by the scanner 14 is calculated using a first hush function, according to the user operation; the hush function is converted using the user's own secret key, and thereby an electronic signature is obtained; and an electronic mail including the original image data, the electronic signature, the electronic certificate and etc., is transmitted to a destination address.

And then, it is judged in Step S86, whether or not an electronic mail including the original data is returned from the recipient (destination address). If such an electronic mail is not returned (NO in Step S86), then it is judged in Step S87, whether or not a predetermined period of time has elapsed. If a predetermined period of time has not elapsed (NO in Step S87), the routine goes back to Step S86. If such an electronic mail is not returned within a predetermined period of time (YES in Step S87), the routine terminates, since it means that the first hush function is suitable for the mailer of the user terminal 2 at the destination address.

In Step S86, if such an electronic mail is returned from the recipient (destination address) (YES in Step S86), the validity of an electronic signature included in the electronic mail is examined, and it is judged in Step S88, whether or not the examination successfully finished. If the examination failed (NO in Step S88), a notice of examination failure is transmitted to the destination address in Step S91. After that, the routine terminates.

If the examination successfully finished (YES in Step S88), a second hush function suitable for the mailer of the user terminal 2 is detected in Step S89. And in Step S90, a hush value for the image data is calculated using the second hush function; the hush value is converted using the secret key created by the image processing apparatus 1, and thereby an electronic signature is obtained; and an electronic mail including the original image data, the electronic signature, the electronic certificate and etc. is transmitted again to the destination address.

As described above, in this embodiment, an existing electronic certificate and secret key created for a user are erased when this user turns ON the “Scan To Email” mode and a new electronic certificate is created for the user. Meanwhile, an existing electronic certificate and secret key created for a user may be erased when this user logs in again and a new electronic certificate is created for the user.

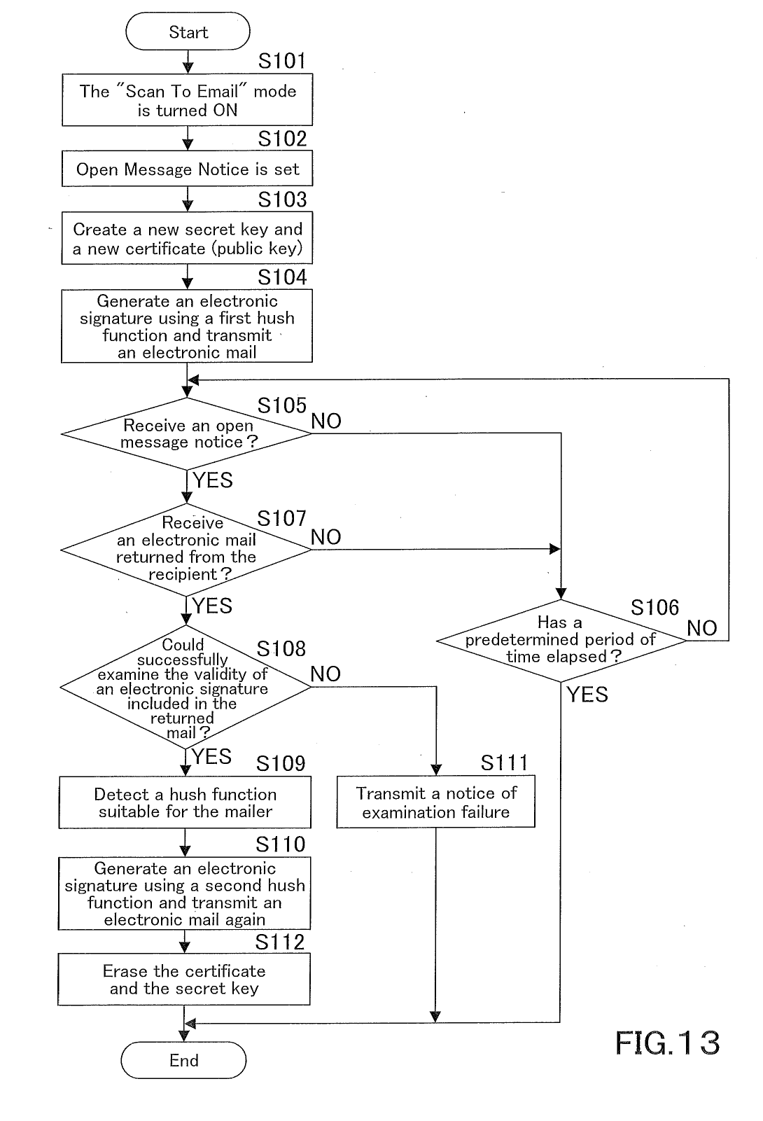

FIG. 13 is a flowchart representing a procedure to erase an existing electronic certificate and secret key yet another time, in which Open Message Notice is set when an electronic mail is transmitted for the first time, and if an open message notice is not returned within a predetermined period of time, an existing electronic certificate and secret key are erased.

A login user turns ON the “Scan To Email” mode and presses the start button of the operation panel 17, then this operation is accepted in Step S101.

Subsequently, Open Message Notice is set in Step S102. After that, a secret key and an electronic certificate (public key) are created for the user in Step S103. The procedure to create a secret key and an electronic certificate (public key) is executed according to the flowchart shown in FIG. 3.

In Step S103, a hush value for image data read out from a document by the scanner 14 is calculated using a first hush function, according to user operation; the hush value is converted using the user's own secret key, and thereby an electronic signature is obtained; and an electronic mail including the original image data, the electronic signature, the electronic certificate and etc., is transmitted to a destination address.

And in Step S105, it is judged whether or not an open message notice is returned from the recipient (destination address). If it is not returned (NO in Step S105), then it is judged in Step S106, whether or not a predetermined period of time has elapsed. If a predetermined period of time has not elapsed (NO in Step S106), the routine goes back to Step S105. If an open message notice is not returned within a predetermined period of time (YES in Step S106), the created electronic certificate and secret key are erased in Step S112.

If an open message notice is returned within a predetermined period of time (YES in Step S105), then it is judged in Step S107, whether or not an electronic mail including the original data is returned from the recipient (destination address). If such an electronic mail is not returned (NO in Step S107), then it is judged in Step S108, whether or not a predetermined period of time has elapsed. If a predetermined period of time has not elapsed (NO in Step S108) the routine goes back to Step S105. If such an electronic mail is not returned within a predetermined period of time (YES in Step S106), the created electronic certificate and secret key are erased in Step S112, since it means that the first hush function is suitable for the mailer of the user terminal 2 at the destination address.

In Step S107, if such an electronic mail is returned from the recipient (destination address) (YES in Step S107), the validity of an electronic signature included in the electronic mail is examined, and it is judged in Step S108, whether or not the examination successfully finished. If the examination failed (NO in Step S108), a notice of examination failure is transmitted to the destination address in Step S111. Then, the routine terminates.

If the examination successfully finished (YES in Step S108), a second hush function suitable for the mailer of the user terminal 2 is detected in Step S109. And in Step S110, a hush value for the image data is calculated using the second hush function; the hush value is converted using the secret key created by the image processing apparatus 1, and thereby an electronic signature is obtained; and an electronic mail including the original image data, the electronic signature, the electronic certificate and etc., is transmitted again to the destination address. After that, the routine proceeds to Step S112, and wherein the created electronic certificate and secret key are erased.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image processing apparatus comprising:
a key creator that creates one set of a secret key and a public key for each user;
a reader that reads out an electronic certificate to certify a user, created by a certificate authority, and the user's own secret key, from a portable recording medium having this electronic certificate and the user's own secret key recorded therein; and
a certificate creator that creates an electronic certificate including the public key created by the key creator, by giving a signature using the user's own secret key read out by the reader.

2. The image processing apparatus recited in claim 1, wherein:
the certificate creator creates the electronic certificate when the user logs in the image processing apparatus or when the user transmits image data to a destination address.

3. The image processing apparatus recited in claim 1, wherein:
electronic certificates hold their own expiration dates; and
the certificate creator is prohibited from creating the electronic certificate if there exists an old electronic certificate which expiration date has not passed.

4. The image processing apparatus recited in claim 1, further comprising:
a storage that records for a while in itself, the secret key created by the key creator.

5. The image processing apparatus recited in claim 1, further comprising:
an eraser that erases the secret key created by the key creator, either when an expiration date of the electronic certificate created by the certificate creator has passed, when the secret key is used, or when the certificate creates a new electronic certificate for the same user.

6. The image processing apparatus recited in claim 1, further comprising:
an ID and password issuer that issues an ID and a password when the certificate creator creates the electronic certificate; and
a memory that records in itself, the ID and the password issued by the ID and password issuer, the secret key created by the key creator and the electronic certificate created by the certificate creator, with a connection to each other.

7. The image processing apparatus recited in claim 1, further comprising:
a transmitter that transmits to a destination address, an electronic mail including image data;
a controller that generates an electronic signature using a hush function and a secret key and gives it to the image data; and
a receiver that receives an electronic mail from the destination address, and
wherein:
the controller generates a first electronic signature using a first hush function and the user's own secret key read out from the portable recording medium and gives it to the image data, and then the transmitter transmits to the destination address, an electronic mail including the image data, the first electronic signature given to the image data by the controller and the user's electronic certificate read out from the portable recording medium, and if the receiver receives from the destination address, an electronic mail including the original data transmitted from the transmitter, the controller generates a second electronic signature using a second hush function and the secret key created by the key creator and gives it to the image data, and then the transmitter transmits to the destination address again, an electronic mail including the image data, the second electronic signature given to the image data by the controller and the electronic certificate created by the certificate creator.

8. An electronic certificate creation method of an image processing apparatus, comprising:
creating one set of a secret key and a public key for each user;
reading out an electronic certificate to certify a user, created by a certificate authority, and the user's own secret key, from a portable recording medium having this electronic certificate and the user's own secret key recorded therein; and
creating an electronic certificate including the public key created for the user, by giving a signature using the user's own secret key read out therefrom.

9. The electronic certificate creation method recited in claim 8, wherein:
the electronic certificate is created when the user logs in the image processing apparatus or when the user transmits image data to a destination address.

10. The electronic certificate creation method recited in claim 8, wherein:
electronic certificates hold their own expiration dates; and
creation of the electronic certificate is prohibited if there exists an old electronic certificate which expiration date has not passed.

11. The electronic certificate creation method recited in claim 8, wherein:
recording for a while in a storage, the secret key created for the user.

12. The electronic certificate creation method recited in claim 8, wherein:
the secret key created for the user is erased either when an expiration date of the electronic certificate created for the user has passed, when the secret key is used, or when a new electronic certificate is created for the same user.

13. The electronic certificate creation method recited in claim 8, wherein:
an ID and a password are issued when the electronic certificate is created for the user; and
the issued ID and password, the secret key created for the user and the electronic certificate created for the user are recorded in a memory with a connection to each other.

14. The electronic certificate creation method recited in claim 8, further comprising:
transmitting to a destination address, an electronic mail including image data;
generating an electronic signature to give to the image data using a hush function and a secret key; and
receiving an electronic mail from the destination address, and
wherein:
a first electronic signature is generated using a first hush function and the user's own secret key read out from the portable recording medium and given to the image data, then an electronic mail including the image data, the first electronic signature and the user's electronic certificate read out from the portable recording medium is transmitted to the destination address, and if an electronic mail including the transmitted original data is received from the destination address, a second electronic signature is generated using a second hush function and the secret key created for the user and given to the image data, then an electronic mail including the image data, the second electronic signature and the electronic certificate created for the user is transmitted again to the destination address.

15. A computer readable recording medium having an electronic certificate creation program recorded therein to make a computer of an image processing apparatus execute:
creating one set of a secret key and a public key for each user;
reading out an electronic certificate to certify a user, created by a certificate authority, and the user's own secret key, from a portable recording medium having this electronic certificate and the user's own secret key recorded therein; and
creating an electronic certificate including the public key created for the user, by giving a signature using the user's own secret key read out therefrom.

16. The computer readable recording medium recited in claim 15, having an electronic certificate creation program recorded therein to make the computer further execute:
creating the electronic certificate when the user logs in the image processing apparatus or when the user transmits image data to a destination address.

17. The computer readable recording medium recited in claim 15, wherein:
electronic certificates hold their own expiration dates, and
having an electronic certificate creation program recorded therein to make the computer further execute:
prohibiting creation of the electronic certificate if there exists an old electronic certificate which expiration date has not passed.

18. The computer readable recording medium recited in claim 15, having an electronic certificate creation program recorded therein to make the computer further execute:
recording for a while in a storage, the secret key created for the user.

19. The computer readable recording medium recited in claim 15, having an electronic certificate creation program recorded therein to make the computer further execute:
erasing the secret key created for the user, either when an expiration date of the electronic certificate created for the user has passed, when the secret key is used, or when a new electronic certificate is created for the same user.

20. The computer readable recording medium recited in claim 15, having an electronic certificate creation program recorded therein to make the computer further execute:
issuing an ID and a password when the electronic certificate is created for the user; and
recording in a memory, the issued ID and password, the secret key created for the user and the electronic certificate created for the user, with a connection to each other.

21. The computer readable recording medium recited in claim 15, having an electronic certificate creation program recorded therein to make the computer further execute:
transmitting to a destination address, an electronic mail including image data;
generating an electronic signature to give to the image data using a hush function and a secret key; and
receiving an electronic mail from the destination address, and
wherein:
a first electronic signature is generated using a first hush function and the user's own secret key read out from the portable recording medium and given to the image data, then an electronic mail including the image data, the first electronic signature and the user's electronic certificate read out from the portable recording medium is transmitted to the destination address, and if an electronic mail including the transmitted original data is received from the destination address, a second electronic signature is generated using a second hush function and the secret key created for the user and given to the image data, then an electronic mail including the image data, the second electronic signature and the electronic certificate created for the user is transmitted again to the destination address.
